(19) United States
(12) Patent Application Publication
(10) Pub. No.: US 2016/0201551 A1
(43) Pub. Date: Jul. 14, 2016

(54) COMBUSTION CHAMBER STRUCTURE FOR ENGINE

(71) Applicant: Mazda Motor Corporation, Hiroshima (JP)

(72) Inventors: Kenji Uchida, Hiroshima-shi (JP); Tatsuya Fujikawa, Higashihiroshima-shi (JP); Masahisa Yamakawa, Hiroshima-shi (JP); Daisuke Asaji, Hiroshima-shi (JP); Kazuhiro Nagatsu, Hiroshima-shi (JP); Takashi Kaminaga, Hiroshima-shi (JP); Toru Miyamoto, Higashihiroshima-shi (JP); Takashi Youso, Hiroshima-shi (JP); Hiroaki Abe, Hiroshima-shi (JP)

(21) Appl. No.: 14/980,243

(22) Filed: Dec. 28, 2015

(30) Foreign Application Priority Data
Jan. 9, 2015 (JP) 2015-003375

(51) Int. Cl. F02B 23/10; F02F 1/42; F02F 3/28

(52) U.S. Cl. CPC F02B 23/101; F02F 3/28; F02F 1/4214

(57) ABSTRACT

A combustion chamber structure for an engine is provided. The structure includes a piston formed with a downward dented cavity in a central part of an upper surface thereof, and a cylinder head forming a combustion chamber having a pent-roof shape. The upper surface of the piston has an annular part extending from an outer edge of the cavity to an outer edge of the upper surface, and surrounding the outer edge of the cavity. The annular part is formed with first and second piston upper surface portions. When the piston is at a top dead center, a ratio of a volume of a space formed between the first piston upper surface portion and a bottom surface of the cylinder head with respect to a volume of a space formed between the second piston upper surface portion and the bottom surface becomes below a predetermined value.

### BACKGROUND

The present invention relates to a combustion chamber structure for an engine, and particularly to a combustion chamber structure for an engine for injecting fuel into a cylinder between a latter half of compression stroke and an early half of expansion stroke and igniting the fuel after a top dead center of the compression stroke within a predetermined engine operating range.

Generally, for engines using gasoline or a fuel mainly containing gasoline, a spark-ignition method in which ignition is performed by an ignition plug is broadly adopted. Recently, in view of improving fuel consumption performance, arts for performing compression self-ignition (specifically, premixed compression self-ignition referred to as homogeneous-charge compression ignition (HCCI)) within a predetermined engine operating range while using gasoline or the fuel mainly containing gasoline by applying a high compression ratio (e.g., 17:1 or higher) as a geometric compression ratio of the engine are developed.

A combustion chamber structure for an engine which performs such compression self-ignition is disclosed in JP2014-043782A, for example. In the art of JP2014-043782A, the combustion chamber structure is applied to a high compression ratio engine and is configured to sufficiently scavenge a cavity formed in a central part of an upper surface of a piston of the engine to improve filling efficiency.

In such an engine for performing the compression self-ignition, within a predetermined engine operating range (e.g., a range where the engine speed is low and the engine load is high), fuel is injected between a latter half of a compression stroke and an early half of an expansion stroke and the fuel is ignited. In this case, since a time length between the fuel injection and the fuel ignition is short, it becomes difficult to uniformly spread a mixture gas inside a combustion chamber. Therefore, a section with lean mixture gas and a section with rich mixture gas are produced inside the combustion chamber. Thus, the mixture gas containing the fuel may be discharged without being combusted or combustion may occur after a scheduled timing (afterburn), resulting in poor fuel consumption. Moreover, smoke is produced and also emission performance degrades.

Therefore, with the engine which performs the compression self-ignition as described above, it is desirable to suitably create a uniform state of the mixture gas inside the combustion chamber after the fuel injection, in other words, it is desirable to swiftly secure a suitable homogeneity of the mixture gas inside the combustion chamber.

Meanwhile, for the sake of convenience in arranging intake and exhaust valves, combustion chambers of which a ceiling (a surface on a cylinder head side) is formed into a gabled roof shape (pent-roof shape) are conventionally adopted. When such a combustion chamber is applied to the engine for performing the compression self-ignition as described above, the mixture gas inside the combustion chamber tends to be non-uniform due to the following reasons.

In the engine using the combustion chamber having the pent-roof shape, a cross section of the combustion chamber taken along a ridge line forming the pent-roof shape (located at a top of the pent roof and corresponding to a line segment where two roofs (inclining surfaces) intersect with each other, hereinafter, suitably referred to as “the pent-roof ridge line”) has a different shape from a cross section of the combustion chamber taken along a line segment perpendicular to the pent-roof ridge line. Therefore, when the piston is at a top dead center, a volume of a space formed between each of portions of an outer edge part of an upper surface of the piston below the pent-roof ridge line (hereinafter, meaning a portion of the piston outward of the cavity) and a bottom surface of a cylinder head (hereinafter, meaning the ceiling of the combustion chamber) is different from a volume of a space formed between each of portions of the outer edge part of the upper surface of the piston below the line segment perpendicular to the pent-roof ridge line and the bottom surface of the cylinder head. Note that each space formed between the outer edge part of the upper surface of the piston and the bottom surface of the cylinder head is generally referred to as “the squish area.”

Since squish areas with different volumes are formed inside the combustion chamber, non-uniform flows occur inside the combustion chamber because a strength of a reverse squish flow (occurring after a top dead center of the compression stroke and causing gas to flow into the spaces between the outer edge part of the upper surface of the piston and the bottom surface of the cylinder head) changes depending on the position inside the combustion chamber. Therefore, with the engine applying with the combustion chamber having the pent-roof shape, due to such non-uniform flows occurred inside the combustion chamber, the mixture gas inside the combustion chamber tends to be non-uniform. As a result, as described above, the fuel consumption degrades due to insufficient combustion or afterburn, or emission performance degrades due to smoke.

### SUMMARY

The present invention is made in view of solving the issues of the conventional art described above, and aims to provide a combustion chamber structure for an engine, which is configured to secure a balance of sizes of squish areas inside a combustion chamber so as to suitably uniformly spread a mixture gas inside the combustion chamber.

According to one aspect of the present invention, a combustion chamber structure for an engine is provided. The engine injects fuel into a cylinder between a latter half of compression stroke and an early half of expansion stroke and ignites the fuel after a top dead center of the compression stroke within a predetermined engine operating range. The combustion chamber structure includes a piston formed with a downward dented cavity in a central part of an upper surface thereof, and a cylinder head forming a combustion chamber having a pent-roof shape, the cylinder head including a fuel injector disposed at a position corresponding to the central part of the piston, and two intake valves and two exhaust valves disposed interposing a ridge line of the pent-roof shape therebetween. The upper surface of the piston has an annular part extending from an outer edge of the cavity to an outer edge of the upper surface of the piston, and surrounding the outer edge of the cavity. The annular part of the piston is formed with a first piston upper surface portion and a second piston upper surface portion, the first piston upper surface portion located on the ridge line of the pent-roof shape when the piston is seen from an upper surface side thereof, the second piston upper surface portion located on a line perpendicular to the ridge line of the pent-roof shape and passing through the central axis of the combustion chamber (corresponding to a central axis of the cylinder) when the piston is seen from the upper surface side thereof. The combustion chamber structure is configured such that when the piston is at the top dead center, a ratio of a volume of a space formed between the first piston upper surface portion and a bottom surface of the cylinder head with respect to a volume of a space formed between the second piston upper surface portion and the bottom surface of the cylinder head becomes below a predetermined value.

With this configuration, when the piston is at the top dead center, the ratio of the volume of the space formed between the first piston upper surface portion and the bottom surface of the cylinder head with respect to the volume of the space formed between the second piston upper surface portion and the bottom surface of the cylinder head becomes below the predetermined value. Thus, balance of sizes of squish areas over the entire combustion chamber can be secured, and variation in strengths of reverse squish flows inside the combustion chamber can suitably be reduced. As a result, after the fuel injection is performed, a state where mixture gas inside the combustion chamber is substantially homogeneous can swiftly be created, in other words, suitable homogeneity of the mixture gas inside the combustion chamber can swiftly be secured. Therefore, degradation of fuel consumption caused by insufficient combustion or afterburn, and degradation of emission performance caused by smoke can be suppressed.

Preferably, the second piston upper surface portion is located lower than the first piston upper surface portion.

With this configuration, when the second piston upper surface portion is located lower than the first piston upper surface portion, the volume of the squish area formed by the second piston upper surface portion can be increased to be closer to the volume of the squish area formed by the first piston upper surface portion. On the other hand, when the first piston upper surface portion is located higher than the second piston upper surface portion, the volume of the squish area formed by the first piston upper surface portion can be reduced closer to the volume of the squish area formed by the second piston upper surface portion. Thus, the ratio of the volume of the squish area formed by the first piston upper surface portion with respect to the volume of the squish area formed by the second piston upper surface portion can suitably become below the predetermined value.

Preferably, the second piston upper surface portion inclines downward and toward the outer edge of the upper surface of the piston based on the incline of the pent-roof shape.

With this configuration, the second piston upper surface portion is inclined downward and toward the outer edge of the upper surface of the piston based on the incline of the pent-roof shape. Therefore, the volume of the squish area formed by the second piston upper surface portion can suitably be increased to be closer to the volume of the squish area formed by the first piston upper surface portion while suitably maintaining the shape, etc. of the cavity.

Preferably, the combustion chamber structure is configured such that when the piston is at the top dead center, the ratio of the volume of the space formed between the first piston upper surface portion and the bottom surface of the cylinder head with respect to the volume of the space formed between the second piston upper surface portion and the bottom surface of the cylinder head becomes substantially 1.

With this configuration, the ratio of the volume of the squish area formed by the first piston upper surface portion with respect to the volume of the squish area formed by the second piston upper surface portion becomes substantially 1, in other words, the volume of the squish area formed by the second piston upper surface portion becomes substantially the same as that of the squish area formed by the first piston upper surface portion. Therefore, the reverse squish flows can surely be produced uniformly inside the combustion chamber.

Preferably, the first piston upper surface portion includes part of the annular part at a position corresponding to between one of the two intake valves and the exhaust valve adjacent to the one of the two intake valves, and part of the annular part at a position corresponding to between the other intake valve and the exhaust valve adjacent to the other intake valve. Preferably, the second piston upper surface portion includes part of the annular part at a position corresponding to between the two intake valves, and part of the annular part at a position corresponding to between the two exhaust valves.

According to another aspect of the present invention, a combustion chamber structure for an engine is provided. The engine injects fuel into a cylinder between a latter half of compression stroke and an early half of expansion stroke and ignites the fuel after a top dead center of the compression stroke. The combustion chamber structure includes a piston formed with a downward dented cavity in a central part of an upper surface thereof, and a cylinder head forming a combustion chamber having a pent-roof shape, the cylinder head including a fuel injector disposed at a position corresponding to the central part of the piston, and two intake valves and two exhaust valves disposed interposing a ridge line of the pent-roof shape therebetween. The upper surface of the piston has an annular part extending from an outer edge of the cavity to an outer edge of the upper surface of the piston, and surrounding the outer edge of the cavity. The annular part of the piston is formed with a first piston upper surface portion and a second piston upper surface portion, the first piston upper surface portion located on the ridge line of the pent-roof shape when the piston is seen from an upper surface side thereof, the second piston upper surface portion located on a line perpendicular to the ridge line of the pent-roof shape and passing through the central axis of the combustion chamber when the piston is seen from the upper surface side thereof. The second piston upper surface portion is located lower than the first piston upper surface portion.

Even with this configuration, balance of sizes of squish areas over the entire combustion chamber can be secured, and reverse squish flows can be produced substantially uniformly inside the combustion chamber.

### BRIEF DESCRIPTION OF THE DRAWINGS

FIG. 1 is a schematic top view of a single cylinder in a cylinder axis direction, the single cylinder applied with a combustion chamber structure for an engine according to one embodiment of the present invention.

FIG. 2 is a top view of a piston in the cylinder axis direction according to the embodiment of the present invention.

FIG. 3 is a partial cross-sectional view of FIG. 1 taken along a line in FIG. 1, including the piston and a cylinder head according to the embodiment of the present invention.

FIG. 4 is a partial cross-sectional view of FIG. 1 taken along a line IV-IV in FIG. 1, including the piston and the cylinder head according to a comparative example.

FIGS. 5A, 5B, and 5C are views similar to FIG. 2, illustrating issues that arise in the comparative example.

FIG. 6 is a partial cross-sectional view of FIG. 1 taken along a line VI-VI in FIG. 1, including the piston and the cylinder head according to the embodiment of the present invention.

### DETAILED DESCRIPTION OF EMBODIMENT

Hereinafter, a combustion chamber structure for an engine according to one embodiment of the present invention is described with reference to the appended drawings.

Before describing the contents of this embodiment of the present invention, a conditional configuration of an engine in this embodiment is briefly described. The engine of this embodiment is operated at a high compression ratio, for example, a geometric compression ratio is 14:1 or higher (suitably, between 17:1 and 18:1). Within a predetermined operating range of the engine (e.g., a range where an engine speed is low and an engine load is high), the engine injects fuel between a latter half of a compression stroke and an early half of an expansion stroke (retarded injection) and ignites the fuel after a top dead center of the compression stroke (CTDC). Further, the engine of this embodiment performs premixed compression self-ignition referred to as HCCI within a predetermined low engine load range. Moreover, the engine of this embodiment is applied with a combustion chamber of which a ceiling on a cylinder head side is formed into a gabled roof shape (pent-roof shape).

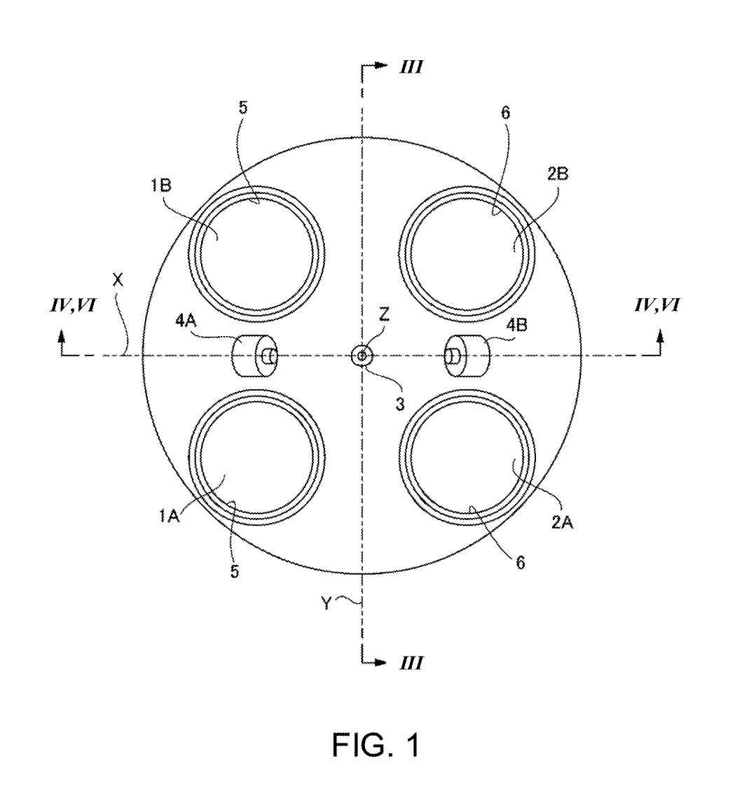

FIG. 1 is a schematic top view of a single cylinder in a cylinder axis direction, the single cylinder applied with the combustion chamber structure for the engine according to this embodiment of the present invention. In FIG. 1, the reference character “Z” indicates a central axis of the cylinder extending in a direction perpendicular to the drawing sheet (cylinder axis), and the reference character “Y” indicates a ridge line (pent-roof ridge line) extending in up-and-down directions of the drawing sheet and having a pent-roof shape that forms the combustion chamber. The pent-roof ridge line Y corresponds to an axial direction of a crankshaft. Further, the reference character “X” indicates a line segment passing through a center of the combustion chamber (i.e., the cylinder axis) and perpendicular to the pent-roof ridge line Y.

As illustrated in FIG. 1, the single cylinder is provided with two intake valves 1A and 1B at one side (left side in FIG. 1) section thereof with respect to the pent-roof ridge line Y. The two intake valves 1A and 1B are arranged in line along the pent-roof ridge line Y. The reference characters “5” in FIG. 1 indicate intake ports opened and closed by the two intake valves 1A and 1B. Hereinafter, when describing the two intake valves 1A and 1B without differentiating them from each other, each of the two intake valves 1A and 1B may simply be referred to as “the intake valve 1.”

Further, the single cylinder is provided with two exhaust valves 2A and 2B at the other side (right side in FIG. 1) section thereof with respect to the pent-roof ridge line Y. The two exhaust valves 2A and 2B are arranged in line along the pent-roof ridge line Y. The reference characters “6” in FIG. 1 indicate exhaust ports opened and closed by the two exhaust valves 2A and 2B. Hereinafter, when describing the two exhaust valves 2A and 2B without differentiating them from each other, each of the two exhaust valves 2A and 2B may simply be referred to as “the exhaust valve 2.”

Moreover, a single fuel injector 3 is disposed in an extension line of the cylinder axis Z. Additionally, a first ignition plug 4A is disposed between the intake valves 1A and 1B, and a second ignition plug 4B is disposed between the exhaust valves 2A and 2B. Hereinafter, when describing the two first and second ignition plugs 4A and 4B without differentiating them from each other, each of the two first and second ignition plugs 4A and 4B may simply be referred to as “the ignition plug 4.”

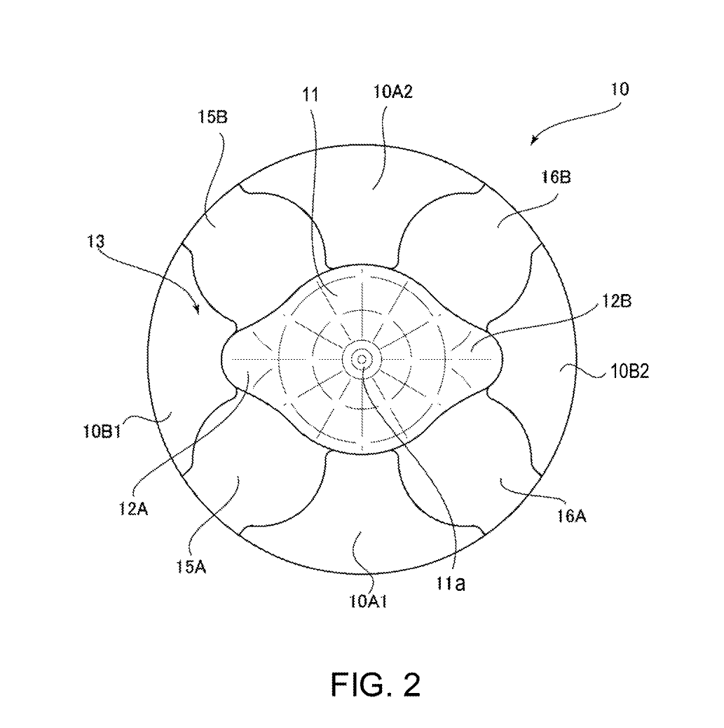

FIG. 2 is a top view of a piston 10 in the cylinder axis direction according to the embodiment of the present invention.

As illustrated in FIG. 2, a downward dented cavity 11 is formed in a central part of an upper surface of the piston 10. The cavity 11 has a circular shape when seen in the direction of the cylinder axis Z, and is formed with a bulge portion 11a at a central portion of the cavity 11. The cavity 11 is further formed with two concave portions 12A and 12B continuous from both side ends of the cavity 11, respectively, to be 180° opposite from each other. The fuel injector 3 is disposed immediately above the bulge portion 11a of the cavity 11, the first ignition plug 4A is disposed within the concave portion 12A when the piston is at the top dead center, and the second ignition plug 4B is disposed within the concave portion 12B when the piston is at the top dead center.

Moreover, the upper surface of the piston 10 has an annular part 13 extending from an outer edge of the cavity 11 (including the concave portions 12A and 12B) to an outer edge of the upper surface of the piston 10, and surrounding the outer edge of the cavity 11 (including the concave portions 12A and 12B). The annular part 13 is formed with four valve recesses 15A, 15B, 16A, and 16B concaving downward by about 1 mm, for example. The valve recess 15A is formed at a position corresponding to the intake valve 1A, the valve recess 15B is formed at a position corresponding to the intake valve 1B, the valve recess 16A is formed at a position corresponding to the exhaust valve 2A, and the valve recess 16B is formed at a position corresponding to the exhaust valve 2B.

Further, the annular part 13 is formed with first piston upper surface portions 10A1 and 10A2 between the valve recesses 15A and 16A and between the valve recesses 15B and 16B, respectively. The annular part 13 is also formed with second piston upper surface portions 10B1 and 10B2 between the valve recesses 15A and 15B and between the valve recesses 16B and 16B, respectively. Specifically, the first piston upper surface portions 10A1 and 10A2 are formed at positions below the pent-roof ridge line Y described above (see FIG. 1), in other words, positions corresponding to between the intake and exhaust valves 1A and 2A and between the intake and exhaust valves 1B and 2B, respectively. Moreover, the second piston upper surface portions 10B1 and 10B2 are formed at positions below the line segment X (perpendicular to the pent-roof ridge line Y and passing through the center of the combustion chamber (see FIG. 1)), in other words, positions corresponding to between the intake valves 1A and 1B and between the exhaust valves 2A and 2B, respectively.

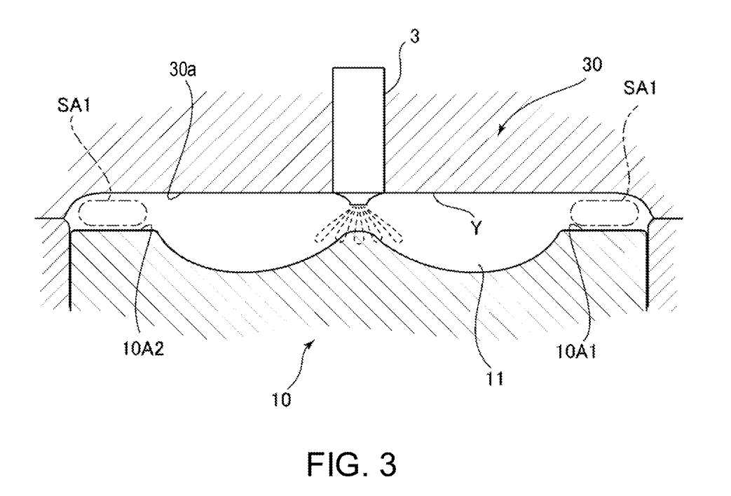

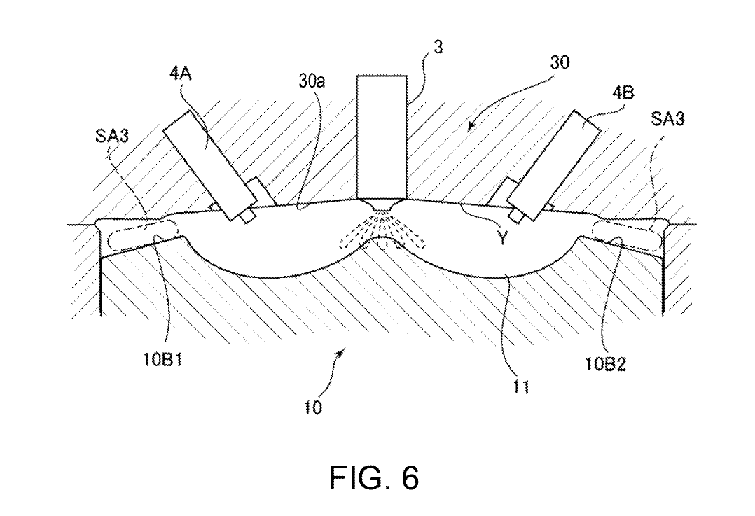

Although described later in detail, in this embodiment, the second piston upper surface portions 10B1 and 10B2 are located lower than the first piston upper surface portions 10A1 and 10A2. Specifically, the first piston upper surface portions 10A1 and 10A2 are formed into flat surfaces (see FIG. 3), and the second piston upper surface portions 10B1 and 10B2 are formed into inclining surfaces (see FIG. 6).

Hereinafter, when describing the first piston upper surface portions 10A1 and 10A2 without differentiating them from each other, each of the first piston upper surface portions 10A1 and 10A2 may simply be referred to as “the first piston upper surface portion 10A,” and when describing the second piston upper surface portions 10B1 and 10B2 without differentiating them from each other, each of the second piston upper surface portions 10B1 and 10B2 may simply be referred to as “the second piston upper surface portion 10B.”

FIG. 3 is a partial cross-sectional view of FIG. 1 taken along a line in FIG. 1, including the piston 10 and a cylinder head 30 according to the embodiment of the present invention. In other words, FIG. 3 is a partial cross-sectional view of FIG. 1 cut by a plane extending in the pent-roof ridge line Y, including the piston 10 and the cylinder head 30. Note that FIG. 3 illustrates a state when the piston 10 is at the CTDC. Further, regarding the fuel injector 3, FIG. 3 illustrates a side view instead of a cross-sectional view.

As illustrated in FIG. 3, in this embodiment, the fuel injector 3 sprays the fuel outward in radial directions of the piston to spread symmetrically with respect to the cylinder axis Z, by using about ten to twelve nozzle holes (not illustrated). In this manner, the fuel spreads uniformly inside the combustion chamber.

Further in FIG. 3, areas with the reference character “SA1” indicate squish areas that are spaces formed between each of the first piston upper surface portions 10A1 and 10A2 and the ceiling of the combustion chamber (i.e., a bottom surface 30a of the cylinder head 30). When the piston 10 elevates on the compression stroke, squish flows in which gas flows radially inward from the respective squish areas SA1 occur. On the other hand, when the piston 10 descends on the expansion stroke, reverse squish flows in which gas flows into the respective squish areas SA1 occur. The strengths of the squish and the reverse squish flows depend on the volume of the squish area SA1.

In FIG. 3, parts of the bottom surface 30a of the cylinder head 30 defining upper sides of the squish areas SA1 are located at a comparatively high position since they are formed by the pent-roof ridge line Y extending substantially horizontally. Thus, each squish area SA1 has a comparatively large space. Therefore, comparatively weak squish and reverse squish flows occur within the squish area SA1.

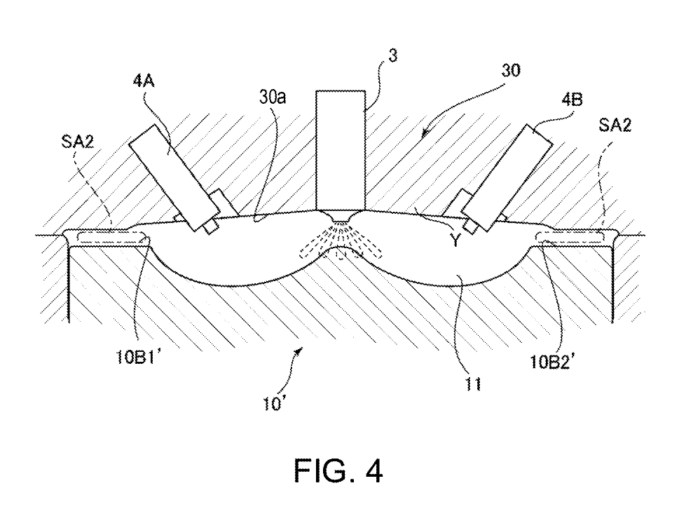

Next, squish areas formed by second piston upper surface portions according to a comparative example are described with reference to FIG. 4. Hereinafter, for the sake of convenience, a piston of the comparative example is referred to as “the piston 10′,” and second piston upper surface portions of the piston 10′ of this comparative example are referred to as “the second piston upper surface portions 10B1′ and 10B2′” or “the second piston upper surface portions 10B′.” The piston 10′ of the comparative example corresponds to one of conventional pistons and is similar to the piston 10 of this embodiment except that the piston 10′ has the second piston upper surface portions 10B1′ and 10B2′ instead of the second piston upper surface portions 10B1 and 10B2. Further, the second piston upper surface portions 10B1′ and 10B2′ of the comparative example are located at the same height as the first piston upper surface portions 10A1 and 10A2.

FIG. 4 is a partial cross-sectional view of FIG. 1 taken along a line IV-IV in FIG. 1 (i.e., cut by a plane extending in up-and-down directions of the piston 10′ along the line segment X perpendicular to the pent-roof ridge line Y), including the piston 10′ and the cylinder head 30 according to the comparative example. Note that FIG. 4 illustrates a state when the piston 10′ is at the CTDC. Further, regarding the fuel injector 3 and the ignition plugs 4, FIG. 4 illustrates side views instead of cross-sectional views.

In FIG. 4, areas with the reference character “SA2” indicate squish areas that are spaces formed between each of the second piston upper surface portions 10B1′ and 10B2′ and the bottom surface 30a of the cylinder head 30. In FIG. 4, parts of the bottom surface 30a of the cylinder head 30 defining upper sides of the squish areas SA2 are located at a comparatively low position since they are formed by respective parts of the inclining surfaces in the pent-roof shape (surfaces inclining downward and toward the outer edge of the upper surface of the piston) and a substantially flat surface connected with lower ends of the inclining surfaces. Thus, each squish area SA2 has a comparatively small space. Therefore, comparatively strong squish and reverse squish flows occur within the squish area SA2 of the comparative example. Specifically, squish and reverse squish flows stronger than within the squish area SA1 in FIG. 3 occur.

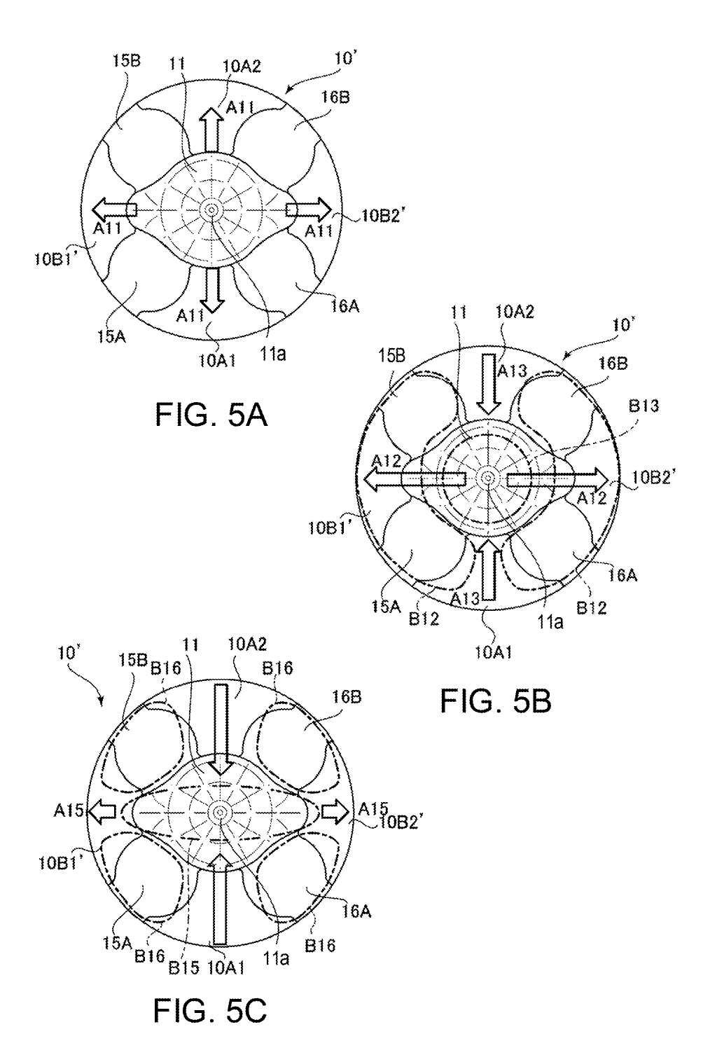

Next, issues that arise in the comparative example described above are described with reference to FIGS. 5A, 5B, and 5C. FIGS. 5A, 5B, and 5C are, similar to FIG. 2, top views of the piston 10′ of the comparative example in the cylinder axis direction, illustrating a chronological flow of combustion caused inside the cylinder having the configuration of the comparative example. Note that in the configuration of the comparative example, the second piston upper surface portions 10B1′ and 10B2′ located at the same height as the first piston upper surface portions 10A1 and 10A2 are applied instead of the second piston upper surface portions 10B1 and 10B2.

As illustrated in FIG. 5A, the fuel spray injected by the fuel injector 3 is first led outward along the cavity 11 (see the arrows A11). Next, as illustrated in FIG. 5B, since the reverse squish flows occurring on the intake and exhaust sides (left and right sides of FIG. 5B) are strong, it is difficult for the fuel spray (before being mixed with air) and the mixture (containing the fuel spray) gas to flow radially inward, and thus, sections with rich mixture gas are formed on the intake and exhaust sides (see the arrows A12 and the sections B12). At the same time, since the reverse squish flows occurring between the intake and exhaust sides (on front and rear sides of FIG. 5B) are weak due to the pent-roof shape, the fuel spray and the mixture gas collided with the cylinder head 30 are sucked into the flows indicated by the arrows A12 and flow toward a central section B13 (see the arrows A13). While flowing as the arrows A13, since the space where the fuel spray and the mixture gas flow is large due to the pent-roof shape and air within the central section B13 is useable, homogenization of the fuel and air is stimulated. Then, as illustrated in FIG. 5C, air left in the central section B13 extends to the intake and exhaust sides (see the arrows A15 and the section B15) due to the flows indicated by the arrows A12 and A13 described above to form a section with lean mixture gas. As a result, a mixture gas distribution in which the rich sections exist at four sides is formed (see the sections B16). When such a mixture gas distribution is formed, the fuel consumption may degrade due to insufficient combustion and afterburn, or emission performance may degrade due to smoke.

Therefore, in this embodiment, to cause the reverse squish flows uniformly inside the combustion chamber after the fuel injection (i.e., to reduce the variation in strengths of the reverse squish flows inside the combustion chamber), a configuration for securing balance of sizes of the squish areas inside the combustion chamber is adopted. Specifically, in this embodiment, a configuration is adopted in which a ratio of the volume of each squish area SA1 (formed between the first piston upper surface portion 10A and the bottom surface 30a of the cylinder head 30) with respect to a volume of a squish area formed between the second piston upper surface portion 10B and the bottom surface 30a of the cylinder head 30 (hereinafter, referred to as “the squish area SA3”) becomes below a predetermined value. More specifically, in this embodiment, by locating the second piston upper surface portion 10B lower than the first piston upper surface portion 10A, the volume of the squish area SA3 formed by the second piston upper surface portion 10B is increased to be closer to the volume of the squish area SA1 formed by the first piston upper surface portion 10A. In this manner, the balance of sizes of the squish areas over the entire combustion chamber is secured so that uniform reserve squish flows occur inside the combustion chamber.

FIG. 6 illustrates the squish areas SA3 formed by the second piston upper surface portions 10B of this embodiment. FIG. 6 is a partial cross-sectional view of FIG. 1 taken along a line VI-VI in FIG. 1 (i.e., cut by the plane extending in the line segment X perpendicular to the pent-roof ridge line Y), including the piston 10 and the cylinder head 30 of this embodiment. Note that FIG. 6 illustrates a state when the piston 10 is at the CTDC. Further, regarding the fuel injector 3 and the ignition plugs 4, FIG. 6 illustrates side views instead of cross-sectional views.

As illustrated in FIG. 6, in this embodiment, the second piston upper surface portions 10B1 and 10B2 incline downward and toward the outer edge of the upper surface of the piston 10. Specifically, each second piston upper surface portion 10B inclines downward and outward from the outer edge of the cavity 11. Therefore, the second piston upper surface portion 10B as a whole is located lower than the first piston upper surface portion 10A. In one example, the second piston upper surface portion 10B is formed by machining a material having a length substantially corresponding to the height of the first piston upper surface portion 10A.

Moreover, as illustrated in FIG. 6, each squish area SA3 is formed between such a second piston upper surface portion 10B and the bottom surface 30a of the cylinder head 30. It can be understood from FIG. 6 that the squish area SA3 is larger than the squish area SA2 in FIG. 4. In this embodiment, the second piston upper surface portion 10B (e.g., inclining angle thereof) is designed according to the inclining surfaces in the pent-roof shape, so that the ratio of the volume of the squish area SA1 formed by the first piston upper surface portion 10A with respect to the volume of the squish area SA3 formed by the second piston upper surface portion 10B becomes below the predetermined value. The predetermined value is set to achieve a ratio with which the flow of the mixture gas caused by the reverse squish flows inside the combustion chamber leads to suitably suppressing degradations of the fuel consumption and the emission performance, in other words, obtaining allowable fuel consumption and emission performance. Preferably, the inclining angle, etc., of the second piston upper surface portion 10B are designed so that the ratio of the volume of the squish area SA1 with respect to the volume of the squish area SA3 becomes substantially 1 (one), in other words, the volume of the squish area SA3 becomes substantially the same as that of the squish area SA1.

Next, operations and effects of the combustion chamber structure for the engine according to this embodiment of the present invention are described.

As described above, according to this embodiment, the second piston upper surface portion 10B is located lower than the first piston upper surface portion 10A so that the ratio of the volume of the squish area SA1 formed by the first piston upper surface portion 10A with respect to the volume of the squish area SA3 formed by the second piston upper surface portion 10B becomes below the predetermined value. Thus, the balance of sizes of the squish areas over the entire combustion chamber can be secured, and the variation in strengths of the reverse squish flows inside the combustion chamber can suitably be reduced. As a result, after the fuel injection is performed, the state where the mixture gas inside the combustion chamber is substantially homogeneous can swiftly be created, in other words, suitable homogeneity of the mixture gas inside the combustion chamber can swiftly be secured. Thus, the degradation of the fuel consumption caused by insufficient combustion or afterburn and the degradation of the emission performance caused by smoke can be suppressed.

Further, according to this embodiment, the second piston upper surface portion 10B is inclined downward and toward the outer edge of the upper surface of the piston 10 based on the inclining surfaces in the pent-roof shape. Therefore, the balance of sizes of the squish areas over the entire combustion chamber can suitably be secured.

Moreover, according to this embodiment, when the second piston upper surface portion 10B is configured so that the ratio of the volume of the squish area SA1 formed by the first piston upper surface portion 10A with respect to the volume of the squish area SA3 formed by the second piston upper surface portion 10B becomes substantially 1 (i.e., the volume of the squish area SA3 is substantially the same as that of the squish area SA1), the reverse squish flows can surely be produced uniformly inside the combustion chamber.

Next, modifications of the combustion chamber structure for the engine according to this embodiment of the present invention are described.

In the embodiment described above, each second piston upper surface portion 10B is located lower than each first piston upper surface portion 10A; however, in one modification, the first piston upper surface portion 10A may be located (formed) higher than the second piston upper surface portion 10B. In this case, the volume of the squish area SA1 formed by the first piston upper surface portion 10A is reduced closer to the volume of the squish area SA3 formed by the second piston upper surface portion 10B. Thus, the ratio of the volume of the squish area SA1 with respect to the volume of the squish area SA3 can be below the predetermined value.

In another modification, instead of locating the second piston upper surface portion 10B lower than the first piston upper surface portion 10A or the first piston upper surface portion 10A higher than the second piston upper surface portion 10B, the part of the bottom surface 30a of the cylinder head 30 opposing to one of the first and second piston upper surface portions 10A and 10B may be formed so that the ratio of the volume of the squish area SA1 with respect to the volume of the squish area SA3 becomes below the predetermined value. In one example, by locating the part of the bottom surface 30a of the cylinder head 30 opposing to the second piston upper surface portion 10B at an even higher position, the volume of the squish area SA3 formed by the second piston upper surface portion 10B can be increased to be closer to the volume of the squish area SA1 formed by the first piston upper surface portion 10A. In another example, by locating the part of the bottom surface 30a of the cylinder head 30 opposing to the first piston upper surface portion 10A at an even lower position, the volume of the squish area SA1 formed by the first piston upper surface portion 10A can be reduced to be closer to the volume of the squish area SA3 formed by the second piston upper surface portion 10B.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1A, 1B Intake Valve
2A, 2B Exhaust Valve
3 Fuel Injector
4A First Ignition Plug
4B Second Ignition Plug
10 Piston
10A1, 10A2 First Piston Upper Surface Portion
10B1, 10B2 Second Piston Upper Surface Portion
11 Cavity
13 Annular Part
15A, 15B, 16A, 16B Valve Recess
30 Cylinder Head
Y Pent-roof Ridge Line
SA1 Squish Area

What is claimed is:

1. A combustion chamber structure for an engine, the engine injecting fuel into a cylinder between a latter half of a compression stroke and an early half of an expansion stroke and igniting the fuel after a top dead center of the compression stroke within a predetermined engine operating range, the combustion chamber structure comprising:
a piston formed with a downward dented cavity in a central part of an upper surface thereof; and
a cylinder head forming a combustion chamber having a pent-roof shape, the cylinder head including:
a fuel injector disposed at a position corresponding to the central part of the piston; and
two intake valves and two exhaust valves disposed interposing a ridge line of the pent-roof shape therebetween,
wherein the upper surface of the piston has an annular part extending from an outer edge of the cavity to an outer edge of the upper surface of the piston, and surrounding the outer edge of the cavity,
wherein the annular part of the piston is formed with a first piston upper surface portion and a second piston upper surface portion, the first piston upper surface portion located on the ridge line of the pent-roof shape when the piston is seen from an upper surface side thereof, the second piston upper surface portion located on a line perpendicular to the ridge line of the pent-roof shape and passing through a central axis of the combustion chamber when the piston is seen from the upper surface side thereof, and
wherein the combustion chamber structure is configured such that when the piston is at the top dead center, a ratio of a volume of a space formed between the first piston upper surface portion and a bottom surface of the cylinder head with respect to a volume of a space formed between the second piston upper surface portion and the bottom surface of the cylinder head becomes below a predetermined value.

2. The structure of claim 1, wherein the second piston upper surface portion is located lower than the first piston upper surface portion.

3. The structure of claim 2, wherein the second piston upper surface portion inclines downward and toward the outer edge of the upper surface of the piston based on the incline of the pent-roof shape.

4. The structure of claim 1, wherein the combustion chamber structure is configured such that when the piston is at the top dead center, the ratio of the volume of the space formed between the first piston upper surface portion and the bottom surface of the cylinder head with respect to the volume of the space formed between the second piston upper surface portion and the bottom surface of the cylinder head becomes substantially 1.

5. The structure of claim 1, wherein the first piston upper surface portion includes part of the annular part at a position corresponding to between one of the two intake valves and the exhaust valve adjacent to the one of the two intake valves, and part of the annular part at a position corresponding to between the other intake valve and the exhaust valve adjacent to the other intake valve, and
wherein the second piston upper surface portion includes part of the annular part at a position corresponding to between the two intake valves, and part of the annular part at a position corresponding to between the two exhaust valves.

6. A combustion chamber structure for an engine, the engine injecting fuel into a cylinder between a latter half of a compression stroke and an early half of an expansion stroke and igniting the fuel after a top dead center of the compression stroke, the combustion chamber structure comprising:
a piston formed with a downward dented cavity in a central part of an upper surface thereof; and
a cylinder head forming a combustion chamber having a pent-roof shape, the cylinder head including:
a fuel injector disposed at a position corresponding to the central part of the piston; and
two intake valves and two exhaust valves disposed interposing a ridge line of the pent-roof shape therebetween,
wherein the upper surface of the piston has an annular part extending from an outer edge of the cavity to an outer edge of the upper surface of the piston, and surrounding the outer edge of the cavity,
wherein the annular part of the piston is formed with a first piston upper surface portion and a second piston upper surface portion, the first piston upper surface portion located on the ridge line of the pent-roof shape when the piston is seen from the upper surface side thereof, the second piston upper surface portion located on a line perpendicular to the ridge line of the pent-roof shape and passing through a central axis of the combustion chamber when the piston is seen from the upper surface side thereof, and
wherein the second piston upper surface portion is located lower than the first piston upper surface portion.
